(19) United States
(12) Patent Application Publication
(10) Pub. No.: US 2026/0227316 A1
(43) Pub. Date: Aug. 6, 2026

(54) AN ASSEMBLY AND A METHOD FOR MEASURING THE SIZE OF DROPLETS OR SOLID PARTICLES SUSPENDED IN TURBID MEDIA: POLARIZATION RATIO IMAGING AFTER MULTIPLE SCATTERING SUPPRESSION

(71) Applicant: SPEC-IMAGING AB, Lund (SE)

(72) Inventors: Edouard BERROCAL, Lund (SE); Elias KRISTENSSON, Bjärred (SE); Mehdi STITI, Lund (SE)

(21) Appl. No.: 19/147,776

(22) PCT Filed: Jan. 17, 2024
(86) PCT No.: PCT/SE2024/050035

§ 371 Date: Jul. 14, 2025

(30) Foreign Application Priority Data
Jan. 17, 2023 (SE) 2350037-4

(51) Int. Cl. G01N 15/1434; G01N 15/00; G01N 15/10; G01N 15/14; G01N 15/1429

(52) U.S. Cl. CPC G01N 15/1434; G01N 15/1012; G01N 15/1431; G01N 2015/0011; G01N 2015/003; G01N 2015/0053; G01N 2015/1014; G01N 2015/1029; G01N 2015/1452; G01N 2015/1493

(57) ABSTRACT

An assembly for measuring size of particles, droplets or bubbles in a dense fluid, may comprise a linearly polarized light source; a polarization adjustment element for rotating the polarization of the linearly polarized light to an adjusted polarization angle; a spatial modulation element arranged to spatially modulate the linearly polarized light into a structured and polarized light profile; sheet generating means to create a structured and polarized light sheet from the structured and polarized light profile; a camera objective arranged to collect side scattered light from particles or droplets illuminated with the structured and polarized light sheet a first 2D sensor arranged to detect a first image of the collected side scattered light through a filter transmitting light of a first polarization direction; a second 2D sensor arranged to detect a second image of the collected side scattered light through a filter transmitting light of a second polarization direction different from the first polarization direction; a processing unit arranged to calculate a first suppressed image and a second suppressed image by suppressing from the first image and the second image, respectively, the light intensity from multiple light scattering; calculate a polarization ratio image by calculating the ration of the first suppressed image and the second suppressed image; and calculate a relative statistical diameter image based on the polarization ratio image. The disclosure further relates to a method for measuring size of particles.

### TECHNICAL FIELD

The present disclosure relates to an assembly and a method for measuring the size of droplets or other particles suspended in a dense fluid. More specifically, the disclosure relates to an assembly and method of sizing liquid and/or solid particles suspended within turbid media as defined in the introductory parts of the independent claims.

### BACKGROUND ART

The measurement of the size of liquid and/or solid particles within turbid media includes various applications. One example concerns atomizing spray systems which are used for clean liquid fuel combustion as well as for efficient industrial processes of spray drying, leading to the production of powders. The optimization of those applications requires the use of a desired droplets size. Such measurement is optically challenging, due to the unwanted emission and detection of multiple light scattering from such turbid media. A second example concerns turbid liquids such as dirty water, blood, beer, milk, etc. Depending on the liquids the sizing of solid particles, cells or gas bubbles is required. However, such measurements are challenging due to liquid turbidity; requesting dilution.

There is, thus, a need of improved techniques for measuring size of droplets or solid particles suspended in liquid or gas.

### SUMMARY

It is an object of the present disclosure to mitigate, alleviate or eliminate one or more of the above-identified deficiencies and disadvantages in the prior art and solve at least the above mentioned problem. According to a first aspect there is provided an assembly for measuring size of particles, droplets or bubbles in a dense fluid, the assembly comprising: a linearly polarized light source; a polarization adjustment element for rotating the polarization of the linear polarized light to an adjusted polarization angle; a spatial modulation element arranged to spatially modulate the polarized light; sheet generating means to create a structured and polarized light sheet from the structured and polarized light profile; a camera objective arranged to collect side scattered light from particles or droplets illuminated with the structured polarized light sheet; a first 2D sensor arranged to detect a first image of the collected side scattered light of a first polarization direction ; a second 2D sensor arranged to detect a second image of the collected side scattered light of a second polarization direction different from the first polarization direction; a processing unit arranged to suppress, in a first step, from the two images the light intensity from multiple light scattering; a processing unit arranged to calculate, in a second step, a polarization ratio image by calculating the ratio of the first image and the second image; and calculate a relative statistical diameter image based on the polarization ratio image. The sheet generating means can be a cylindrical lens, a number of cylindrical lenses or a slit. Basically any optics that can reshape the light profile of the linearly polarized light source into a sheet.

The problems mentioned in the background section are thereby solved. A technique is thus provided that allows to obtain measurements of the droplet, bubble or particle diameter in turbid fluid without dilution and without using any dyes in the fluid, the fluid being a gas or a liquid. Particles is to be interpreted broad as either solid particles, bubbles in denser fluid as liquid or liquid droplets. A dye or adsorbent could still be added to reduce ripple effects of Mie scattering and increase the signal, which could be important in case of single shot measurements.

According to some embodiments, a first filter transmitting light of a first polarization direction is arranged in front of the first 2D sensor and a second filter transmitting light of a second polarization direction is arranged in front of the second 2D sensor.

According to some embodiments, the assembly comprises: an optical splitter arranged to split the collected side scattered light in a first signal propagation path and a second signal propagation path; the first 2D sensor arranged to detect a first image of the collected side scattered light in the first signal propagation path, wherein the first 2D detector comprises the polarization filter transmitting light of a first polarization direction; a second 2D sensor arranged to detect a second image of the collected side scattered light in the second signal propagation path, wherein the second 2D detector comprises the polarization filter transmitting light of a second polarization direction different from the first polarization direction.

According to some embodiments, the assembly comprises: a polarized optical splitter arranged to split the collected side scattered light of a first polarization direction in a first signal propagation path and light of a first polarization direction, different from the first polarization direction, in a second signal propagation path; the first 2D sensor arranged to detect a first image of the collected side scattered light in the first signal propagation path; a second 2D sensor arranged to detect a second image of the collected side scattered light in the second signal propagation path.

According to some embodiments, the processing unit is further configured to calculate an absolute statistical diameter image based on the polarization ratio image and a calibration table of polarization ratio to particle or droplet diameter. The diameter is thereby measured and can provide insights about the diameter of droplets or particles suspended in fluid, which in many situations has to be measured. It could e.g. be measurements for checking quality of water in waste water or drinking water, pollution or impurities in fuel, breathing air or gases. According to some embodiments, the spatial modulation element is a Diffractive Optical Element or a periodic wave optical element as e.g. a Ronchi Grating. An advantage of using a Ronchi grating is that the structure may in some cases be much easier to handle and may thereby be preferred even though the signal strength will decrease compared to a high transmitting DOE. An advantage using a Diffractive Optical Element is that a structured modulation is achieved with minimal intensity losses.

According to some embodiments, the camera objective is a telecentric lens or a telecentric objective. The telecentric lens collects light uniformly so the signal is collected in the same way over the sensor, basically the telecentric lens collects light of the same angle in every pixel position. This is a big advantage to when calculating the ratio according to the present disclosure.

According to some embodiments, the polarization adjustment element (11) is configured to adjust the polarization around 45 degrees. The polarization adjustment element (11) may e.g. be a half-wave plate.

According to some embodiments, the first polarization direction is 90 degrees (perpendicular polarization) and the second polarization direction is zero degrees (parallel polarization). In that way it is made sure that the first 2D sensor and the second 2D sensor measure different polarizations that can be used to calculate the polarization ratio image.

According to a second aspect there is provided a method for measuring size of particles, bubbles or droplets in a dense fluid, the method comprising modulating a linearly polarized light sheet with a spatial modulation element into a structured and polarized light sheet; illuminating the fluid with the structured and polarized light sheet; collecting side scattered light using a camera objective; detecting at a first polarization direction a first image of the collected side scattered light in the first signal propagation path; detecting at a second polarization direction a second image the collected side scattered light in the second signal propagation path; calculating a first suppressed image and a second suppressed image by suppressing from the first image and the second image the light intensity from multiple light scattering calculating a polarization ratio image by calculating the ratio of the first suppressed image and the second suppressed image; calculating a relative statistical diameter image based on the polarization ratio image.

The problems mentioned in the background section are thereby solved. A technique is thus provided that allows to obtain measurements of the droplet or particle diameter without using any dyes in the fluid, the fluid being a gas or a liquid. Particles is to be interpreted broad as either solid particles or liquid droplets. A dye or adsorbent could still be added to reduce ripple effects of Mie scattering and increase the signal, which could be important in case of single shot measurements.

According to some embodiments, the method comprises: splitting the collected side scattered light in a first signal propagation path and a second signal propagation path; detecting at a first polarization direction a first image of the collected side scattered light in the first signal propagation path a with a first 2D sensor; detecting at a second polarization direction a second image the collected side scattered light in the second signal propagation path a with a second 2D sensor.

According to some embodiments, the method comprises: calculating an absolute statistical diameter image based on the polarization ratio image and a calibration table of polarization ratio to particle or droplet diameter.

According to some embodiments, the method comprises: repeating detecting at a first polarization direction a first image of the collected side scattered light in the first signal propagation path a with a first 2D sensor; detecting at a second polarization direction a second image the collected side scattered light in the second signal propagation path a with a second 2D sensor at a second modulation that is phase shifted compared to the first modulation. A full 2D image of the diameter distribution can thereby be calculated without any shadows caused by the DOE.

According to some embodiments, detecting the side scattered light by the first 2D sensor and the second 2D sensor, respectively, is performed over an exposure time of 10-100 ms to produce a smoothing of the Mie signal detected by the first 2D sensor and the second 2D sensor, respectively.

According to some embodiments, the method comprises preparing the calibration table of polarization ratio to particle or droplet diameter by Phase Doppler Anemometry measurements of the diameters of suspended droplets or particles compared to the calculated relative statistical diameter image. An accurate calculation of an absolute diameter image can thereby be obtained.

Effects and features of the second aspect are to a large extent analogous to those described above in connection with the first aspect. Embodiments mentioned in relation to the first aspect are largely compatible with the second aspect.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1a shows the optics producing the structured light profile used to illuminate the particles suspended in fluid according to an embodiment of the present disclosure.

FIG. 1b shows the optics producing the structured light profile used to illuminate the particles suspended in fluid according to a further embodiment of the present disclosure.

FIG. 1c shows the optics producing the structured light profile used to illuminate the particles suspended in fluid according to a still further embodiment of the present disclosure.

FIG. 2a shows a top view of parts of the assembly according to an embodiment of the present disclosure.

FIG. 2b shows a top view of parts of the assembly according to a different embodiment of the present disclosure.

FIG. 2c shows a flow chart disclosing how an embodiment according to the present disclosure is performed using measurement on spray droplets as an example.

FIG. 3 shows a flow chart of the illustrating the steps of the second aspect of the present disclosure.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

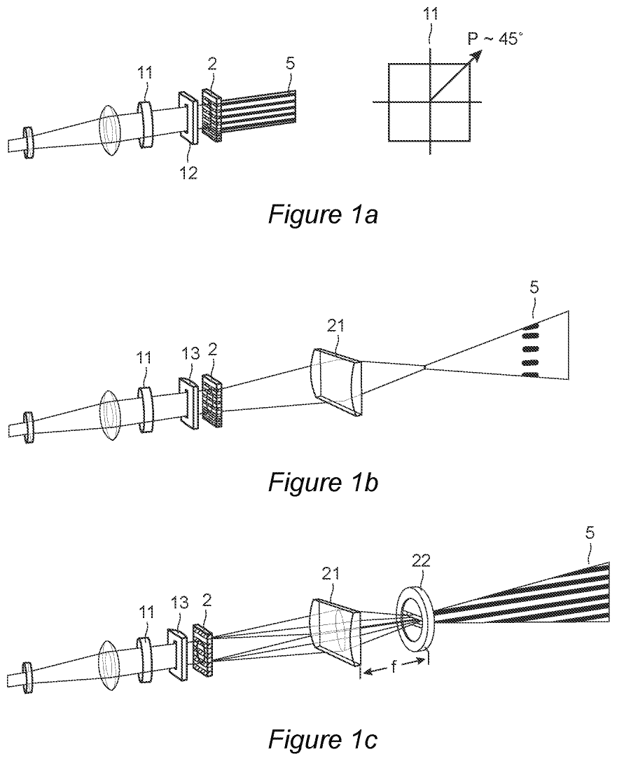

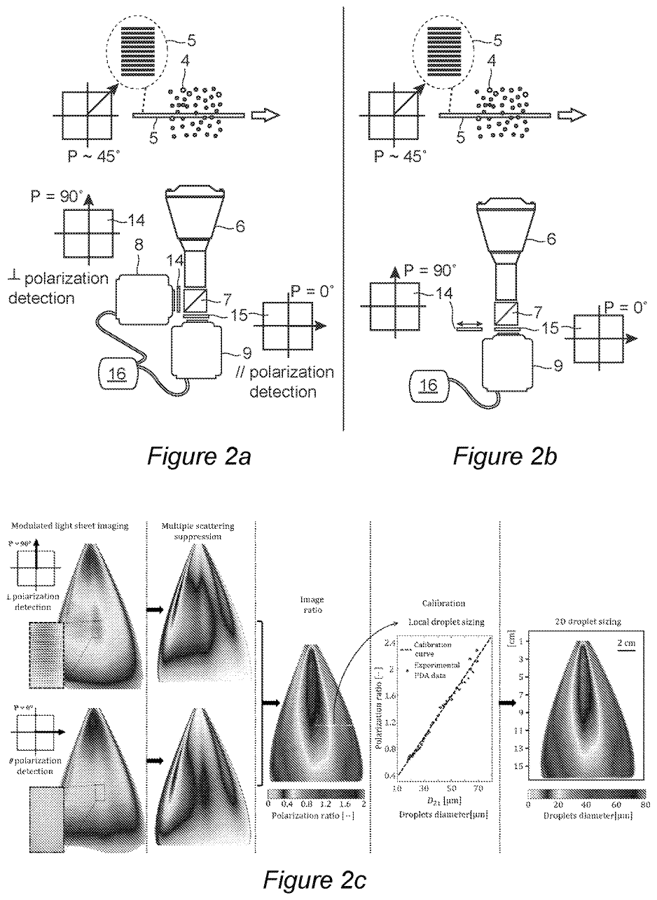

With reference to FIGS. 1a to 2a the first aspect of this disclosure is disclosed. An assembly for measuring size of particles, droplets or bubbles in a dense fluid, the assembly comprising: a linearly polarized light source; a polarization adjustment element 11 for rotating the polarization of the linearly polarized light to an adjusted polarization angle; a spatial modulation element 2 arranged to spatially modulate the linearly polarized light into a structured and polarized light profile; sheet generating means 12,13,21 to create a structured and polarized light sheet 5 from the structured and polarized light profile; a camera objective 6 arranged to collect side scattered light from particles or droplets illuminated with the structured and polarized light sheet 5; a first 2D sensor 8 arranged to detect a first image of the collected side scattered light through a filter transmitting light of a first polarization direction 14; a second 2D sensor 9 arranged to detect a second image of the collected side scattered light through a filter transmitting light of a second polarization direction 15 different from the first polarization direction; a processing unit 16 arranged to calculate a first suppressed image and a second suppressed image by suppressing from the first image and the second image, respectively, the light intensity from multiple light scattering; calculate a polarization ratio image by calculating the ratio of the first suppressed image and the second suppressed image; and calculate a relative statistical diameter image based on the polarization ratio image.

The processing unit 16 is configured to calculate an absolute statistical diameter image based on the polarization ratio image and a calibration table of polarization ratio to particle or droplet diameter.

With reference to the embodiment of FIG. 2b the assembly further comprises an optical splitter 7 arranged to split the collected side scattered light in a first signal propagation path and a second signal propagation path; the first 2D sensor 8 arranged to detect a first image of the collected side scattered light in the first signal propagation path, wherein the first 2D sensor comprises the polarization filter transmitting light of a first polarization direction 14; a second 2D sensor 9 arranged to detect a second image of the collected side scattered light in the second signal propagation path, wherein the second 2D sensor comprises the polarization filter transmitting light of a second polarization direction 15 different from the first polarization direction.

The spatial modulation element 2 can be a Diffractive Optical Element DOE or a periodic wave optical element as e.g. a Ronchi Grating.

The camera objective 6 is in FIG. 2 a telecentric lens or a telecentric objective. The telecentric lens collects light uniformly so the signal is collected in the same way over the sensor, basically the telecentric lens collects light of the same angle in every pixel position. This is a big advantage to when calculating the ratio according to the present disclosure.

The polarization adjustment element (11) is configured to adjust the polarization to ~45 degrees so that the light illuminating the particles or droplets is polarized in ~45 degrees. The polarization filter transmitting light of the first polarization direction 14 transmits light with 90 degrees polarization (perpendicular polarization) and the polarization filter transmitting light of the second polarization direction 15 transmits light with zero degrees polarization (horizontal polarization).

FIG. 1 discloses the optics of the sheet generating means 12,13,21 shaping the sheet intended to irradiate the sample of particles or droplets. In FIG. 1 discloses three different setups for creating the structured and polarized light sheet 5 that is used to collect the signal as disclosed in FIG. 2.

FIG. 1a discloses a setup where the beam is first expanded by lenses, then polarized to 45 degrees by the half-wave plate 11, passing through a slit to form a light sheet before being modulated by a spatial modulation element 2, the modulating element being a Ronchi grating. The result is a structured and polarized light sheet 5 where the structured light is polarized in 45 degrees.

FIG. 1b discloses a setup where the beam is first expanded by lenses, then polarized to 45 degrees by the half-wave plate 11, passing through cylindrical lens 13 before being modulated by a spatial modulation element 2, the spatial modulating element being a Ronchi grating. The structured and polarized light sheet 5 then passes a second cylindrical lens 21 being vertically aligned in relation to the cylindrical lens 13. The result is a structured and polarized light sheet 5 where the structured light is polarized in 45 degrees and where the square pattern of the Ronchi pattern is imaged.

FIG. 1c discloses a setup where the beam is first expanded by lenses, then polarized to 45 degrees by the half-wave plate 11, passing through cylindrical lens before being modulated by a spatial modulation element 2, the modulating element being a Ronchi grating or a diffractive optical element. The structured and polarized light sheet 5then passes a second cylindrical lens 21, being vertically aligned in relation to the cylindrical lens 13, and a frequency pattern 22. The result is a structured and polarized light sheet 5where the structured light is polarized in 45 degrees and where the structure pattern is maintained over distance.

FIG. 2a is a top view of the structured and polarized light sheet 5propagating through the sample of particles or droplets 4. FIG. 2a further discloses the telecentric lens 6, the optical beam splitter 7 that divides the side scattering from the sample collected by the telecentric lens 6 into two parts. The first part, reflected to the left in FIG. 2a is filtered by the first polarization filter 14 to only contain light polarized in 90 degrees. The second part, reflected downwards in FIG. 2a is filtered by the second polarization filter 15 to only contain light polarized in zero degrees. The two signals of different polarization are collected by the first 2D sensor 8 and the second 2D sensor 9, respectively. The first 2D sensor 8 and the second 2D sensor 9 are both connected to a processing unit arranged to calculate a first suppressed image and a second suppressed image by suppressing from the first image and the second image, respectively, the light intensity from multiple light scattering; calculate the polarization ratio image by calculating the ratio of the first suppressed image and the second suppressed image and then calculate the relative statistical diameter image based on the polarization ratio image. The result is then saved in a memory of the processing unit for display of distribution to an operator of the assembly.

In FIG. 2b an embodiment similar to the one in FIG. 2a is disclosed. Instead of using two 2D sensors to collect different polarization of the scattered light only one 2D sensor is used. After taking one image with the setup using the polarization filter 15, the polarizations filter 15 is changed to polarization filter 14 and a second image is detected. This can be done when measuring in stable turbid fluids as a stable spray of droplets e.g. as disclosed in the measurement examples of FIG. 2c.

FIG. 2c discloses how the method according to the second aspect is performed. The first section of FIG. 2c to the left discloses modulated light sheet imaging of a spray of droplets at two polarization angles (0 and 90 degrees). In the second part multiple scattering is suppressed in each of the images using Structured Laser Illumination Planar Imaging. The ratio between the two images at different polarization are calculated and compared to the calibration curve in the next section of FIG. 2c to convert the ratio of each pixel to a diameter to crate the resulting image in the last section to the right of FIG. 2c where each pixel has a diameter value representing the diameter of the droplet in that pixel

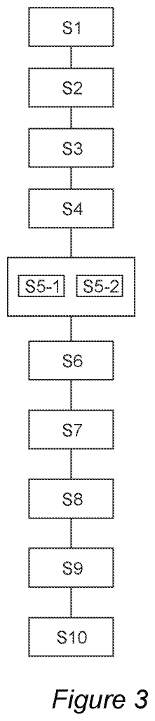

The second aspect of this disclosure is illustrated in FIG. 3 disclosing a method for measuring size of particles, bubbles or droplets in a dense fluid, the method comprising modulating S1 a linearly polarized light sheet with a spatial modulation element 2 into a structured and polarized light sheet 5; illuminating S2 the fluid with the structured and polarized light sheet 5; collecting S3 side scattered light using a camera objective; detecting S5-1 at a first polarization direction a first image of the collected side scattered light in the first signal propagation path; detecting S5-2 at a second polarization direction a second image the collected side scattered light in the second signal propagation path; calculating S7 a first suppressed image and a second suppressed image by suppressing from the first image and the second image the light intensity from multiple light scattering calculating S8 a polarization ratio image by calculating the ratio of the first suppressed image and the second suppressed image; calculating S9 a relative statistical diameter image based on the polarization ratio image.

The method optionally further comprises: splitting S4 the collected side scattered light in a first signal propagation path and a second signal propagation path; detecting S5-1 at a first polarization direction a first image of the collected side scattered light in the first signal propagation path a with a first 2D sensor; detecting S5-2 at a second polarization direction a second image the collected side scattered light in the second signal propagation path a with a second 2D sensor.

The method optionally further comprises: calculating S10 an absolute statistical diameter image based on the polarization ratio image and a calibration table of polarization ratio to particle or droplet diameter.

The method optionally comprises: repeating S6 the steps S1 to S5-2 at a second modulation that is phase shifted compared to the first modulation.

The detecting S5-1, S5-2 of the side scattered light by the first 2D sensor and the second 2D sensor, respectively, is performed over an exposure time of 10-100 ms to produce a smoothing of the signal detected by the first 2D sensor and the second 2D sensor, respectively.

The method may further optionally comprise preparing the calibration table of polarization ratio to particle or droplet diameter by Phase Doppler anemometry PDA measurements of the diameters of suspended droplets or particles compared to the calculated relative statistical diameter image.

The person skilled in the art realizes that the present disclosure is not limited to the preferred embodiments described above. The person skilled in the art further realizes that modifications and variations are possible within the scope of the appended claims. For example, a person skilled in the art understands that a number of the optical components disclosed in the FIGS. 1 and 2 can be rearranged along the propagation path of the light of the linearly polarized light source, still producing the same structured and polarized light sheet 5 as disclosed in the Figures. The two polarization filters 14, 15 in FIG. 2 could also be omitted if the beam splitter 7 a is separating the different polarization directly. Additionally, variations to the disclosed embodiments can be understood and effected by the skilled person in practicing the claimed disclosure, from a study of the drawings, the disclosure, and the appended claims.

1. An assembly for measuring size of particles, droplets or bubbles in a dense fluid, the assembly comprising:
a linearly polarized light source;
a polarization adjustment element for rotating the polarization of the linearly polarized light to an adjusted polarization angle;
a spatial modulation element arranged to spatially modulate the linearly polarized light into a structured and polarized light profile;
sheet generating means to create a structured and polarized light sheet from the structured and polarized light profile;
a camera objective arranged to collect side scattered light from particles or droplets illuminated with the structured and polarized light sheet;
a first 2D sensor arranged to detect a first image of the collected side scattered light of a first polarization direction;
a second 2D sensor arranged to detect a second image of the collected side scattered light of a second polarization direction different from the first polarization direction;
a processing unit arranged to
calculate a first suppressed image and a second suppressed image by suppressing from the first image and the second image, respectively, a light intensity from multiple light scattering;
calculate a polarization ratio image by calculating the ratio of the first suppressed image and the second suppressed image; and
calculate a relative statistical diameter image based on the polarization ratio image;
wherein the processing unit is further configured to calculate an absolute statistical diameter image based on the polarization ratio image and a calibration table of polarization ratio to particle or droplet diameter.

2. The assembly according to claim 1, further comprising:
a first filter transmitting light of a first polarization direction is arranged in front of the first 2D sensor, and
a second filter transmitting light of a second polarization direction is arranged in front of the second 2D sensor.

3. The assembly according to claim 1, further comprising:
an optical splitter arranged to split the collected side scattered light in a first signal propagation path and a second signal propagation path;
the first 2D sensor arranged to detect a first image of the collected side scattered light in the first signal propagation path, wherein s first 2D detector comprises the polarization filter transmitting light of a first polarization direction
a second 2D sensor arranged to detect a second image of the collected side scattered light in the second signal propagation path, wherein a second 2D detector comprises the polarization filter transmitting light of a second polarization direction different from the first polarization direction.

4. The assembly according to claim 1, wherein the spatial modulation element is a Diffractive Optical Element (DOE) or a periodic wave optical element as e.g. a Ronchi Grating.

5. The assembly according claim 1, wherein the camera objective is a telecentric lens or a telecentric objective.

6. The assembly according to claim 1, wherein the polarization adjustment element is configured to adjust the polarization to 45 degrees.

7. The assembly according to claim 1, wherein the first polarization direction is 90 degrees and the second polarization direction is zero degrees.

8. A method for measuring size of particles, bubbles or droplets in a dense fluid, the method comprising
modulating (S1) a linearly polarized light sheet with a spatial modulation element into a structured and polarized light sheet;
illuminating (S2) the fluid with the structured and polarized light sheet;
collecting (S3) side scattered light using a camera objective;
detecting (S5-1) at a first polarization direction a first image of the collected side scattered light in a first signal propagation path;
detecting (S5-2) at a second polarization direction a second image the collected side scattered light in a second signal propagation path;
calculating (S7) a first suppressed image and a second suppressed image by suppressing from the first image and the second image a light intensity from multiple light scattering
calculating (S8) a polarization ratio image by calculating the ratio of the first suppressed image and the second suppressed image;
calculating (S9) a relative statistical diameter image based on the polarization ratio image;
calculating (S10) an absolute statistical diameter image based on the polarization ratio image and a calibration table of polarization ratio to particle or droplet diameter.

9. The method according to claim 8, further comprising:
splitting (S4) the collected side scattered light in a first signal propagation path and a second signal propagation path;
detecting (S5-1) at a first polarization direction a first image of the collected side scattered light in the first signal propagation path a with a first 2D sensor;
detecting (S5-2) at a second polarization direction a second image the collected side scattered light in the second signal propagation path a with a second 2D sensor.

10. The method according to claim 8, further comprising:
repeating (S6) the steps S1 to S5-2 at a second modulation that is phase shifted compared to a first modulation.

11. The method according to claim 8, wherein detecting (S5-1, S5-2) the side scattered light by the first 2D sensor and the second 2D sensor, respectively, is performed over an exposure time of 10-100 ms to produce a smoothing of the signal detected by the first 2D sensor and the second 2D sensor, respectively.

12. The method according to claim 8, further comprising
preparing the calibration table of polarization ratio to particle or droplet diameter by Phase Doppler anemometry (PDA) measurements of the diameters of suspended droplets or particles compared to the calculated relative statistical diameter image.
